(19) United States
(12) Patent Application Publication
(10) Pub. No.: US 2023/0226485 A1
(43) Pub. Date: Jul. 20, 2023

(54) DEVICES, SYSTEMS, FACILITIES AND PROCESSES FOR CO2 CAPTURE AND SEQUESTRATION FROM POWER GENERATION FACILITIES

(71) Applicant: Next Carbon Solutions, LLC, Houston, TX (US)

(72) Inventors: Ivan Van der Walt, Conroe, TX (US); Vikrum Subra, Houston, TX (US); Ben Heichelbech, Houston, TX (US); Connor Rivard, Houston, TX (US); Alex Thompson, Sugar Land, TX (US)

(21) Appl. No.: 17/992,709

(22) Filed: Nov. 22, 2022

Related U.S. Application Data
(60) Provisional application No. 63/282,941, filed on Nov. 24, 2021.

(51) Int. Cl. B01D 53/14; E21B 41/00; F02C 6/18

(52) U.S. Cl. CPC B01D 53/1475; E21B 41/0064; F02C 6/18; B01D 2257/504; B01D 2258/0283

(57) ABSTRACT

A power generation facility includes a process for capturing and sequestering CO2 generated from the facility turbines. The systems may include a heat recovery steam generator, a heat exchanger, a capture unit, and a sequestration compression unit that are configured to cool the flue gas, absorb CO2 therefrom, compress the flue gas, and send the compressed CO2 rich gas stream to sequestration of some form, thereby reducing the overall emissions from the facility.

### CROSS REFERENCE TO RELATED APPLICATIONS

The present application claims the benefit of priority to U.S. Provisional Application No. 63/282,941 filed Nov. 24, 2021, the entirety of which is incorporated herein by reference.

### BACKGROUND

Power generation facilities that are coal or gas fired contribute to greenhouse gases. Greenhouse gases comprise various gaseous components such as carbon dioxide, methane, nitrous oxide, hydrofluorocarbons, perfluorocarbons, and sulfur hexafluoride that absorb radiation, trap heat in the atmosphere and generally contribute to undesirable environmental green-house effects.

Power generation facilities often implement certain forms of hydrocarbon reduction technologies such as scrubbers and flares. However, typically these facilities do not have a dedicated process specifically designed to reduce most greenhouse gas emissions.

Power generation facilities need to improve the overall efficiency of the facility and reduce greenhouse gas emissions.

### SUMMARY

A power generation facility may include a flue gas stream from the turbines that contains some concentration of CO2, which typically would be released to the atmosphere. The power generation facility of the present disclosure includes devices and systems for capturing and sequestering CO2.

In a first aspect of the present disclosure, which may be combined with any other aspect listed herein unless specified otherwise, the power generation facility includes a duct firing system configured to receive the flue gas from the power facility turbines and/or an existing Heat Recovery Steam Generator (HRSG) unit in order to increase a temperature and a mass flow of the flue gas. p

In a second aspect of the present disclosure, which may be combined with any other aspect listed herein unless specified otherwise, the flue gas from the duct firing system may be sent to a further HRSG unit to produce steam from the increased temperature and mass of the flue gas. In some embodiments, the duct firing system separates first and second sections within a single HRSG unit. The steam produced from the further HRSG unit or section may be sent to a power generator to power the power facility users, with the excess power optionally being sold to the power grid. Additionally, the steam may be sent to the power steam users, such as the regenerator reboiler, to be used in the carbon capture process, with the excess steam used for facility power.

In a third aspect of the present disclosure, which may be combined with any other aspect listed herein unless specified otherwise, the flue gas from the HRSG unit may be sent to a heat exchanger to be cooled. Additionally, exhaust flue gas from the existing or first HRSG unit may be directed to an inlet upstream of the heat exchanger unit, bypassing the duct firing and the second HRSG unit. In some embodiments, the heat exchanger for cooling the flue gas is a gas/air heat exchanger utilizing ambient air as the cooling medium for the flue gas. In other embodiments, the heat exchanger is a direct contact cooler utilizing water as the cooling medium for the flue gas.

In a fourth aspect of the present disclosure, which may be combined with any other aspect listed herein unless specified otherwise, the cooled flue gas from the heat exchanger unit is sent to a capture unit. The capture unit may include a commercially available absorbing media for CO2, such as amine, ammonia, ionic fluids, sodium carbonate, methanol, potassium chloride, and any other industrially available solvents, and an absorber for absorbing CO2 from the flue gas. The treated flue gas from, for example, the top of an absorber column may be released to the atmosphere with less than about 5% CO2 of the initial flue gas stream.

In a fifth aspect of the present disclosure, which may be combined with any other aspect listed herein unless specified otherwise, the rich solvent from the capture unitmay be sent to a regenerator unit where energy is applied to the rich solvent releasing the CO2 to create a lean solvent. The lean solvent from the regenerator unit may be sent back to the capture unit for additional CO2 absorption.

In a sixth aspect of the present disclosure, which may be combined with any other aspect listed herein unless specified otherwise, the sequestration compression unit may include a compressor that is electric, steam, or gas driven. The compressor may compress the CO2 rich gas stream, and the sequestration compression unit may then convey the compressed CO2 rich gas stream to sequestration via pipeline, truck, train, or rail. In the case of the gas driven compressor, the CO2 emitted from the gas driver may be recycled back to an inlet of the existing HRSG or to a further HRSG unit if there is no existing HRSG at the existing facility.

In a seventh aspect of the present disclosure, which may be combined with any other aspect listed herein unless specified otherwise, the compressed CO2 rich stream is transported to a sequestration site either on land, sea, a geological formation containing a saline aquifer to be permanently sequestered, used for enhanced oil recovery, or to be used as feedstock for other industrial users. If sequestration options are not available, the compressed CO2 rich stream may be sent to a storage tank to be used in power production, syngas production, or to be combined with aggregate CO2. For power production, the liquid CO2 which is stored can act as a “peak shaving” facility and evaporate the liquid CO2 as power is required. This liquid CO2 may be expanded into gas to drive a set of turbines to generate electricity. The gas may then be returned to a dome to be stored and compressed into liquid to start the cycle again.

Additional features and advantages of the disclosed devices, systems, and methods are described in and will be apparent from the following Detailed Description and the Figures. The features and advantages described herein are not all-inclusive and in particular many additional features and advantages will be apparent to one of ordinary skill in the art in view of the figures and description. Also, any particular embodiment does not have to have all of the advantages listed herein. Moreover, it should be noted that the language used in the specification has been principally selected for readability and instructional purposes, and not to limit the scope of the inventive subject matter.

### BRIEF DESCRIPTION OF THE FIGURES

Understanding that the figures depict only typical embodiments of the invention and are not to be considered to be limiting the scope of the present disclosure, the present disclosure is described and explained with additional specificity and detail through the use of the accompanying figure.

FIG. 1 illustrates an exemplary schematic of a power generation facility configured to direct flue gas from the turbine to sequestration or storage.

### DETAILED DESCRIPTION OF EXAMPLE EMBODIMENTS

The detailed description is to be construed as exemplary only and does not describe every possible embodiment, as describing every possible embodiment would be impractical, if not impossible. One of ordinary skill in the art could implement numerous alternate embodiments, which would still fall within the scope of the claims. To the extent that any term is referred to in a manner consistent with a single meaning, that is done for the sake of clarity and illustration only, and it is not intended that such claim term be limited to that single meaning.

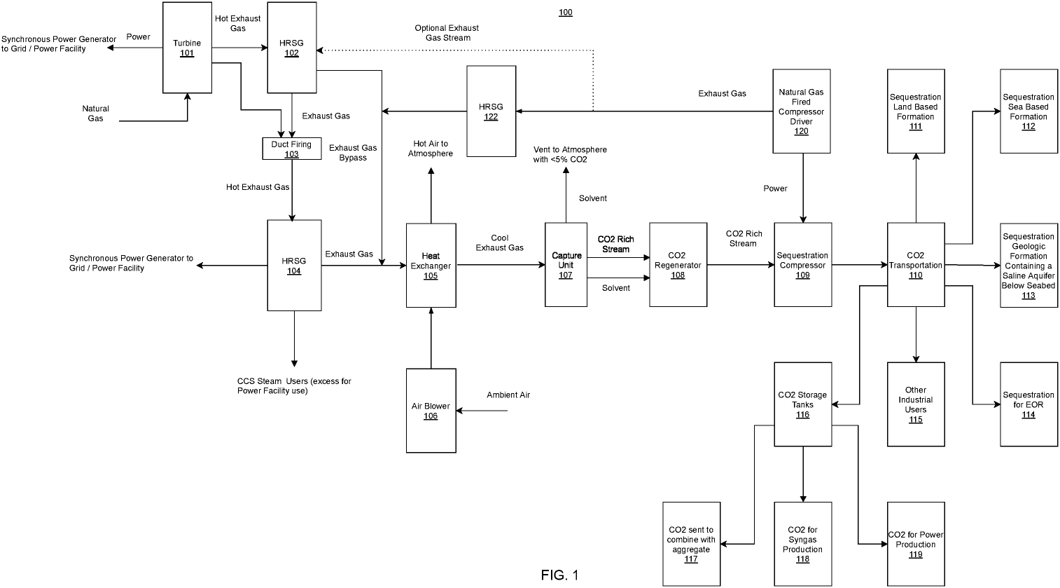

FIG. 1 illustrates an exemplary schematic of a power generation facility 100 with the flue gas generating at a turbine unit being sent to sequestration or storage.

The turbine unit 101 receives natural gas via pipeline and consumes or processes the natural gas to generate synchronous power, which may be sent to a power grid. Flue gas from the turbine unit 101 includes of a percentage of CO2 and may be sent to an existing or first HRSG unit 102, which generates additional synchronous power to be sent to the power grid and/or a power generation facility. Steam may also be generated at the first HRSG unit 102 and can be used by power generation facility steam users.

The flue gas from the first HRSG unit 102 may be sent to a duct firing unit 103, where the temperature and the mass flow of the flue gas may be increased. The flue gas may then be sent to a second HRSG unit 104, which may generate synchronous power for the power grid and additional steam for the power facility users. In another embodiment, the HRSG unit 102 and the second HRSG unit 104 are the first and second sections in a single HRSG unit separated by the duct firing unit 103. The flue gas from the second HRSG unit 104 may be sent to a heat exchanger 105 to reduce the temperature of the flue gas prior to CO2 absorption at the capture unit 107. Alternatively, the exhaust gas from the first HRSG 102 may be sent directly to the heat exchanger 105, bypassing the duct firing unit 103 and the second HRSG 104.

In some embodiments, the heat exchanger 105 may be a gas/air heat exchanger, and air may be provided by an electric or steam driven air blower 106, which is sized accordingly to blow ambient air through the heat exchanger unit 105. The hot ambient air from the heat exchanger unit 105 may be released to the atmosphere. In some embodiments, the heat exchanger 105 may be a direct contact cooler which uses water as the cooling medium for the flue gas stream.

The cooled flue gas from the heat exchanger unit 105 may be sent to the CO2 absorber capture unit 107, where the CO2 may be absorbed through a commercially available absorbent media. The capture unit may include a CO2 absorber/regenerator and a liquid commercially available absorbent for absorbing CO2. In the capture unit 107, the absorber and absorbent absorbs CO2 from the cooled flue gas stream. Treated gas containing less than about 5% CO2 may be vented to the atmosphere. The capture unit 107 may be designed to achieve about 50% turndown capacity while still achieving a capture rate of about 95%. The CO2 rich flue gas and/or the rich solvent containing CO2 from the capture unit 107 may be sent to a CO2 regenerator 108, where the CO2 may be removed from the rich solvent using heat or another form of energy, creating a lean solvent. The lean solvent having undergone the regeneration process at the CO2 regenerator 108 may be returned to the capture unit 107.

The CO2 rich gas from the regenerator unit 108 may be sent to a sequestration compressor unit 109, which includes a sequestration compressor. The sequestration compressor may be natural gas, steam, or electric driven and is configured to compress the flue gas into a compressed CO2 rich stream. If the compressor includes a natural gas compressor driver 120 as shown in FIG. 1, exhaust gas from the compressor 120 may sent to the existing HRSG unit 102 or, if there is not an existing HRSG unit 102, to an additional HRSG unit 122. If there is an existing HRSG unit 102, then HRSG unit 122 may not be required. In the case that the compressor driver of the sequestration compression unit 109 is steam or electric (not shown), then there will be no CO2 emissions from the driver. The compressor of the sequestration compression unit 109 may be driven by existing steam generated from the facility 100 or by an electric motor. The sequestration compression unit 109 may also include one or more knockout drums for collecting any remaining liquid in the gas stream. Liquids from the knockout drums within sequestration compression units may be sent back to the facility to be stored or disposed of via truck. The sequestration compressor may be designed to achieve 50% turndown capacity while still sequestering the full amount of CO2.

The compressed CO2 rich stream may then be then sent to CO2 transportation 110 to be transported though pipeline, truck, rail, or any other commercially feasible methods and sequestered. The compressed CO2 rich stream may be sequestered in a land-based formation 111, a sea based formation 112, in a geological formation containing a saline aquifer below a seabed 113, and/or be used for enhanced oil recovery (EOR) 114 in a partially depleted hydrocarbon reservoir. The sequestration site may also be a region on top of a seabed, at a depth greater than three kilometers below sea level, or below a seabed. For example, the sequestration site may be a region below a seabed, wherein the seabed is located at a depth greater than about 3.0 kilometers below sea level.

In some embodiments, a portion of the compressed CO2 rich stream may be sent as raw material for other industrial users 115. The compressed CO2 rich stream may be sent to liquid CO2 storage tanks 116, to be combined with aggregate 117, to be used in syngas production 118, and/or to be used in power production 119. For power production, the liquid CO2 which is stored can act as a “peak shaving” facility and evaporate the liquid CO2 as power is required. This liquid CO2 can be expanded into gas to drive a set of turbines to generate electricity. The gas may be returned to a dome to be stored and compressed into liquid to start the cycle again.

The system 100 may also include ancillary heating equipment that may run full time to support the heating requirements of the facility. This support may be needed in order to handle a turndown of about 0-50% with a low capture yield and a fast response on increased capture rate when the system is ramped up.

All percentages expressed herein are by weight of the total weight of the composition unless expressed otherwise. As used herein, “about,” “approximately” and “substantially” are understood to refer to numbers in a range of numerals, for example the range of -10% to +10% of the referenced number, preferably -5% to +5% of the referenced number, more preferably -1% to +1% of the referenced number, most preferably -0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “an ingredient or “the ingredient” means “at least one ingredient” and includes two or more ingredients.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. A composition “consisting essentially of” contains at least 75 wt. % of the referenced components, preferably at least 85 wt. % of the referenced components, more preferably at least 95 wt. % of the referenced components, most preferably at least 98 wt. % of the referenced components.

The terms “at least one of” and “and/or” used in the respective context of “at least one of X or Y” and “X and/or Y” should be interpreted as “X,” or “Y,” or “X and Y.” For example, “at least one of honey or chicory root syrup” should be interpreted as “honey without chicory root syrup,” or “chicory root syrup without honey,” or “both honey and chicory root syrup.”

Where used herein, the terms “example” and “such as,” particularly when followed by a listing of terms, are merely exemplary and illustrative and should not be deemed to be exclusive or comprehensive. The many features and advantages of the present disclosure are apparent from the written description, and thus, the appended claims are intended to cover all such features and advantages of disclosure. Further, since numerous modification and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable no or in the future.

We claim:

1. A system for treating, compressing, and sequestering CO2 derived from flue gas of a power plant turbine, the system comprising:
a Heat Recovery Steam Generator (HRSG) unit configured to receive the flue gas from the power plant turbine and to produce steam;
a heat exchanger configured to cool the flue gas from the HRSG unit;
a capture unit configured to receive the flue gas from the heat exchanger and remove CO2 from the flue gas, the capture unit including a CO2 absorber and an absorbent;
a sequestration compression unit configured to compress the flue gas into compressed CO2 rich stream and to convey the compressed CO2 rich stream towards at least one of a sequestration site, a storage tank, or at least one industrial user, the sequestration compression unit comprising a compressor driven by one of natural gas, steam, electric, or supercritical CO2.

2. The system of claim 1, further comprising a duct firing unit configured to receive the flue gas from the power plant turbine and to increase a temperature and a mass flow of the flue gas, the HRSG unit receiving the flue gas from the duct firing unit.

3. The system of claim 1, wherein the system is configured to direct the steam produced by the HRSG unit to a power generator, and the power generator is configured to provide power to other facility users and/or to a power grid.

4. The system of claim 1, wherein the system is configured to direct the steam from the HRSG unit to one or more power facility users and/or to power the power facility.

5. The system of claim 1, wherein the sequestration compressor unit comprises a gas driven compressor, and the system is configured to direct exhaust gas from the gas driven compressor to the HRSG unit.

6. The system of claim 1, the sequestration site is selected from the group consisting of a region below a sea based formation (seabed), a region in a geological formation containing a saline aquifer below the seabed, a partially depleted hydrocarbon reservoir for enhanced oil recovery (EOR), and combinations thereof.

7. The system of claim 1, wherein the system is configured to transport the compressed CO2 rich stream to at least one industrial user as feedstock.

8. The system of claim 1, wherein the system is configured to transport the compressed CO2 rich stream to a storage tank.

9. The system of claim 8, wherein the system is configured to combine the compressed CO2 rich stream from the storage tank with aggregate CO2 from other sources to form a combined CO2 gas stream and using the combined CO2 gas stream in at least one of syngas production, power production, or peakshaving.

10. The system of claim 1, comprising a separate HRSG unit configured to receive the exhaust gas generated from the compressor of the sequestration compression unit and to send additional flue gas upstream of the heat exchanger.

11. The system of claim 1, wherein the heat exchanger is a gas/air heat exchanger configured to use ambient air as the cooling medium for the flue gas.

12. The system of claim 11, further comprising an air blower configured to provide the ambient air to the gas/air heat exchanger.

13. The system of claim 1, wherein the heat exchanger is a direct contact cooler configured to use water as the cooling medium for the flue gas.

14. A process for treating, compressing, and sequestering CO2 derived from flue gas of a power plant turbine, the process comprising:
receiving, at a Heat Recovery Steam Generator (HRSG) unit, the flue gas from the power plant turbine and generating steam;
cooling, at a heat exchanger, the flue gas from the HRSG unit;
receiving, at a capture unit, the flue gas from the heat exchanger and absorbing CO2 from the flue gas;
compressing, at a sequestration compression unit, the flue gas from the capture unit into a compressed CO2 rich stream, the sequestration compression unit including a compressor; and
conveying, by the sequestration compression unit, the compressed CO2 gas stream towards at least one of a sequestration site, a storage tank, or at least one industrial user.

15. The process of claim 14, further comprising receiving, by a power generator, the steam generated by the HRSG unit and providing power to a power grid.

16. The process of claim 14, wherein the sequestration site is selected from the group consisting of a region on top of a seabed, a region below a seabed, a region in a geological formation containing a saline aquifer below the seabed, existing wells for enhanced oil recovery, and combinations thereof.

17. The process of claim 14, wherein the heat exchanger is a gas/air heat exchanger configured to use ambient air as a cooling medium.

18. The system of claim 14, wherein the heat exchanger is a direct contact cooler configured to use water as a cooling medium.

19. The process of claim 14, wherein the compressor of the sequestration compression unit is driven by natural gas, and the process comprises directing exhaust gas from the compressor to the HRSG unit.

20. The process of claim 14, comprising transporting the compressed CO2 rich stream to at least one industrial user as feedstock.

21. The process of claim 14, comprising transporting the compressed CO2 rich stream to a storage tank.

22. The process of claim 21, further comprising combining the compressed CO2 rich stream from the storage tank with aggregate CO2 from other sources to form a combined CO2 gas stream and using the combined CO2 gas stream in at least one of syngas production, power production, or peakshaving.

23. A process for treating, compressing, and sequestering CO2 derived from flue gas of a power plant turbine, the process comprising:
receiving, at a duct firing unit, the flue gas from the power plant turbine and increasing a temperature and a mass flow of the flue gas;
receiving, at a Heat Recovery Steam Generator (HRSG) unit, the flue gas from the duct firing unit and generating steam;
cooling, at a heat exchanger, the flue gas from the HRSG unit;
receiving, at a capture unit, the flue gas from the heat exchanger and absorbing CO2 from the flue gas;
compressing, at a sequestration compression unit, the flue gas from the capture unit into a compressed CO2 rich stream, the sequestration compression unit including a compressor driven by natural gas;
directing exhaust gas from the compressor to the HRSG unit; and
conveying, by the sequestration compression unit, the compressed CO2 gas stream towards at least one of a sequestration site, a storage tank, or at least one industrial user.

24. The process of claim 23, wherein the sequestration site is selected from the group consisting of a region on top of a seabed, a region below a seabed, a region in a geological formation containing a saline aquifer below the seabed, existing wells for enhanced oil recovery, and combinations thereof.

25. The process of claim 23, wherein the heat exchanger is a gas/air heat exchanger, and the process comprises the gas/air heat exchanger using ambient air as a cooling medium.

26. The process of claim 23, wherein the heat exchanger is a direct contact cooler, and the process comprises the direct contact cooler using water as a cooling medium.

27. The process of claim 23, comprising transporting the compressed CO2 rich stream to at least one industrial user as feedstock.

28. The process of claim 23, comprising transporting the compressed CO2 rich stream to a storage tank.

29. The system of claim 28, further comprising combining the compressed CO2 rich stream from the storage tank with aggregate CO2 from other sources to form a combined CO2 gas stream and using the combined CO2 gas stream in at least one of syngas production, power production, or peakshaving.
